(19) United States
(12) Patent Application Publication
(10) Pub. No.: US 2026/0215377 A1
(43) Pub. Date: Jul. 30, 2026

(54) Plant Lighting System

(71) Applicant: New AeroFarms, Inc., Ringgold, VA (US)

(72) Inventors: Ahmed Basyouny, Wayne, NJ (US); Randal Reiman, Saddle Brook, NJ (US); Casey Schwichtenberg, Astoria, NY (US)

(73) Assignee: New AeroFarms, Inc., Ringgold, VA (US)

(21) Appl. No.: 19/144,810

(22) PCT Filed: Dec. 27, 2023
(86) PCT No.: PCT/US2023/086105

§ 371 Date: Jun. 30, 2025

Related U.S. Application Data
(60) Provisional application No. 63/436,176, filed on Dec. 30, 2022.

(51) Int. Cl. A01G 9/24; A01G 31/02; F21V 21/22

(52) U.S. Cl. CPC A01G 9/249; A01G 31/025; F21V 21/22

(57) ABSTRACT

Systems and methods for positioning artificial lighting lamps across extended vertical growing towers are disclosed. The system can accurately and repeatedly position the lighting lamps in close proximity to the plant canopy vertical grow tower surfaces. A plant lighting system may include a light fixture frame that supports one or more lighting lamps, a first linear actuator, and a second linear actuator. The light fixture frame may be mounted to the top surface of the first linear actuator and to the top surface of the second linear actuator such that the light fixture frame spans the first linear actuator and the second linear actuator.

### CROSS-REFERENCE TO RELATED APPLICATION

The present application claims priority benefit to a US provisional patent application entitled “Plant Lighting System, that was filed on Dec. 30, 2022, and assigned Ser. No. 63/436,176. The entire content of the foregoing provisional application is incorporated herein by reference.

### TECHNICAL FIELD

This disclosure relates generally to systems, methods and an apparatus for positioning artificial lighting lamps used for growing plants in vertical growing towers.

### BACKGROUND

Lighting lamps can be provided between levels of a vertical growing tower. The lights are generally fixed to the vertical growing tower and the distance between the plants and lighting is not easily changed. However, adjustment of the distance between the plants and the lighting may be desired to accommodate for the change in height of the plants during the growing process.

In greenhouses, cables have been used to support frames containing lighting lamps from above. The support frames are suspended from the cables and a winch mechanism is used to raise and lower the frame. A winch system can be difficult to use and move light assemblies up evenly and smoothly within a plant growing environment. Further, because the cables are free to move in any direction, the frames can sway and change position due to airflow within the vertical farm, workers that contact the suspended frames, or plants that contact the frames as they grow. In indoor farms having rows of vertical growing towers in close proximity to one another, the position of growing equipment, plants, and workers needs to be carefully controlled for safety and to minimize variation in the growing environment. The use of cables to adjust the position of support frames containing lighting lamps on each level in the growing tower environment can therefore be cumbersome and complex.

The efficient use of energy and photons produced by artificial lighting lamps is important to minimize costs associated with indoor growing facilities. Swaying light assemblies and/or poorly positioned light assemblies can lead to inefficient lighting of plants and can cause yield losses due to non-uniform lighting of plants, especially near the edges of the grow media.

As such, there exists a continuing need for improved systems and methods for positioning artificial lighting lamps used for growing plants in indoor vertical farms.

### SUMMARY

The embodiments disclosed herein meets these and other needs by providing a plant lighting system that can include a light fixture frame that supports lighting lamps, the light fixture frame has a first side, a second side opposite the first side, a third side joining the first side and the second side, and a fourth side opposite the third side that joins the first side and the second side. The plant lighting system can further include a first linear actuator that has a fully retracted length and a fully extended length, the fully extended length can be a multiple or approximately a multiple of the length of the fully retracted length of the linear actuator. The first linear actuator has a base surface and a top surface. The plant lighting system can include a second linear actuator that has a fully retracted length and a fully extended length, the fully extended length of the second linear actuator can be a multiple or approximately a multiple of the length of the fully retracted length of the second linear actuator. The second linear actuator has a base surface and a top surface. The second linear actuator is spaced apart from the first linear actuator. The first linear actuator and the second linear actuator can consist of segments, the linear actuators extend and retract the segments telescopically. The light fixture frame can be mounted to the top surface of the first linear actuator and the light fixture frame can be mounted to the top surface of the second linear actuator. The light fixture frame can span between the first linear actuator and the second linear actuator, or the light fixture frame can overlap and extend past the first linear actuator and the second linear actuator.

In some embodiments of the disclosure the plant lighting system can further include a third linear actuator that has a fully retracted length and a fully extended length. The fully extended length of the third linear actuator can be a multiple or approximately a multiple of the length of the fully retracted length of the linear actuator. The third linear actuator has a base surface and a top surface. The light fixture frame can be mounted to the top surface of the third linear actuator. The third linear actuator can be mounted to the light fixture frame between the first linear actuator and the second linear actuator.

In other embodiments of the disclosure the grow tower can further include a grow media structure. The grow media structure can include grow media. The grow media structure can include a grow media and a container. The grow media structure has a height that can be measured between a top surface of the grow media structure and the base surface of the grow media structure. The height of the grow media structure can be less than the fully retracted length of the linear actuator. In embodiments of the disclosure a base surface of the grow media structure can be positioned at or above the base surface of the fully retracted linear actuators and a top surface the grow media structure can be positioned at or below the top surface of the fully retracted linear actuators. In some embodiments of the plant lighting system the grow media structure can be positioned below the light frame fixture when the linear actuators are at the fully retracted length position.

Embodiments of the disclosure can include a grow tower that includes the plant lighting system as described herein, the base of the first linear actuator is fixtured proximate to a first end portion of the grow tower, and the base of the second linear actuator is fixtured proximate to a second end portion of the grow tower. The light fixture frame can span between the first end portion of the grow tower and the second end portion of the grow tower. The third side of the light fixture frame nearest the grow tower can be separated by at least a gap from a surface or plane of the grow tower. The grow tower can further include a third linear actuator. The base of the third linear actuator can be fixtured proximate to the grow tower. The third linear actuator can be positioned between the first linear actuator and the second linear actuator and can be aligned or form a straight line including the first actuator and the second actuator.

In some embodiments of the grow tower, the base of the first linear actuator can be fixtured to a first end portion of the grow tower and the base of the second linear actuator can be fixtured to a second end portion of the grow tower. In some embodiments the base of the third linear actuator can be fixtured to the grow tower.

In embodiments of the plant lighting system the third side of the light fixture frame nearest the grow tower can be separated by the gap from a surface or plane of the grow tower during vertical movement of the light fixture frame from a position where the actuators are fully retracted and a position where the actuators are fully extended.

In embodiments of the grow tower of the disclosure including the plant lighting system, the base of the first linear actuator can be positioned below the grow media or base surface of the grow media structure, the top surface of the first linear actuator can be positioned above the grow media or top surface of the grow media structure when the first linear actuator is in the fully retracted position, and the base of the second linear actuator can be positioned below the grow media or grow media structure, and the top of the second linear actuator can be positioned above the grow media or grow media structure when the second linear actuator is in the fully retracted position.

In embodiments of the grow tower including the plant lighting system, a third linear actuator and the base of the third linear actuator can be positioned below the grow media or grow media structure and the top of the third linear actuator can be positioned above the growth media or grow media structure when the third linear actuator is in a fully retracted position.

In some embodiments of the grow tower of the disclosure the grow tower can include one or more independently position controllable plant lighting systems and one or more independently position controllable grow media structures (e.g., with the position of the plant lighting system(s) and the grow media structure(s) controllable independently from each other). The plant grow system can include an upper light fixture frame comprising lighting lamps that can be supported by a first set of linear actuators and a grow media structure comprising a grow media and a container that can be supported by a second independent set of linear actuators. The first set of linear actuators and the second set of linear actuators can be raised and lowered independently from one another. The first set of linear actuators and the second set of linear actuators can separated from each other by a distance and the first set of linear actuators and the second set of linear actuators can be raised and lowered independently. In some embodiments the grow media structure can have a lower light fixture frame positioned below grow media structure. In other embodiments of the plant grow system the lower light fixture frame positioned below the grow media structure can be supported by a third set of linear actuators. The first set of linear actuators, the second set of linear actuators, and the third set of linear actuators can be raised and lowered independently.

Embodiments of the disclosure can include a method of growing plants in the plant grow system including: the upper light fixture frame comprising lighting lamps that can be supported by a first set of linear actuators, the grow media structure comprising a grow media and a container that can be supported by a second independent set of linear actuators, and the lower light fixture frame positioned below the grow media structure that can be supported by a third set of linear actuators. The method can include the acts or steps of: (a) changing a height of the light fixture frame by actuating the first set of linear actuators to maintain a substantially constant separation between the lighting lamps and the grow media structure or a plant shoot system canopy of the developing plants within the grow media structure; (b) changing a height of the grow media structure by actuating the second set of synchronized linear actuators to maintain a separation between the plant shoot system and an obstruction (ground, lights, frames) below the grow media structure; (c) changing a height of the lower light fixture frame positioned below the grow media structure; or any combination of (a), (b), and (c).

In some embodiments of the disclosure the method can include developing plants wherein the plants produce stolons.

Embodiments of the disclosure can include those where the linear actuators are synchronized linear actuators.

Embodiments of the disclosure can include those where the light fixture frame can include light fixture frame sections that are joined together and wherein each section supports a set of elongated lighting lamps.

Unlike cables use in winch systems for raising and lowering lights, the linear actuators in embodiments of the disclosure can be rigid between the retracted position and the extended position, and can enable the light fixture frame to maintain a gap between the frame and a surface or plane of the grow tower. The exemplary systems therefore provide for accurate positioning and adjustment of the light fixture frame relative to the surface or plane of the grow tower to allow for optimized growing of the developing plants.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIG. 1 illustrates a lighting system;

FIG. 2 illustrates a portion of a lighting system;

FIG. 3 illustrates an end portion of a lighting system;

FIG. 4 illustrates a perspective view of a grow tower that includes a lighting system with actuators in an extended position and grow media structures;

FIG. 5 illustrates a perspective view of a portion of a grow tower that includes a lighting system with actuators in a retracted position and grow media structures;

FIG. 6 illustrates an end view of a grow tower that includes a lighting system with actuators in a retracted position, and grow media structures;

FIG. 7 illustrates a perspective view of a portion of a grow tower that includes a lighting system and grow media structures;

FIG. 8 illustrates a perspective view of a portion of a grow tower that includes a lighting system and grow media structures;

FIG. 9A illustrates a perspective view of a plant growing system; and

FIG. 9B illustrates an end view a plant growing system.

### DETAILED DESCRIPTION

In the following description, it is understood that terms such as “top,” “bottom,” “outward,” “inward,” and the like are words of convenience and are not to be construed as limiting terms. Reference will now be made in detail to embodiments of the disclosure, which are illustrated in the accompanying figures. Referring to the drawings in general, it will be understood that the illustrations are for the purpose of describing particular embodiments of the disclosure and are not intended to limit the same.

Whenever a particular embodiment of the disclosure is said to comprise or consist of at least one element of a group and combinations thereof, it is understood that the embodiment may comprise or consist of any of the elements of the group, either individually or in combination with any of the other elements of that group.

These, and other, aspects of the disclosure will be better appreciated and understood when considered in conjunction with the following description and the accompanying drawings. The following description, while indicating various embodiments of the disclosure and numerous specific details thereof, is given by way of illustration and not of limitation. Many substitutions, modifications, additions or rearrangements may be made within the scope of the disclosure, and the disclosure includes all such substitutions, modifications, additions or rearrangements.

In embodiments of the disclosure, the term “developing plant(s)” can refer to one or more germinating seeds, one or more seedlings with or without true leaves, one or more growing plants, or any combination of these that are on a generally top surface of the growth medium.

Embodiments of the disclosure include a lighting system or plant lighting system. The lighting system can include a light fixture frame that supports one or more lighting lamps. The light fixture frame can have a first side, a second side opposite the first side, a third side joining the first side and the second side, and a fourth side opposite the third side that joins the first side and the second side. The lighting system can further include a first linear actuator that has a fully retracted length and a fully extended length. In some embodiments the fully extended length of the actuator is substantially a multiple of the fully retracted length of the actuator (segments nest within one another). The first linear actuator has a base surface and a top surface. The lighting system can further include a second linear actuator that has a fully retracted length and a fully extended length. The second linear actuator has a base surface and a top surface. In some embodiments the fully extended length of the second linear actuator is substantially a multiple of the fully retracted length of the actuator. The second linear actuator can be spaced apart from the first linear actuator. The light fixture frame can be mounted to the top surface of the first linear actuator and the light fixture frame can be mounted to the top surface of the second linear actuator. The light fixture frame can span between the first and second linear actuators or the light fixture frame can extend past the first linear actuator and the second linear actuator. The lighting system can be used to provide light to develop plants, seedlings, and germinate seeds. In some embodiments of the disclosure the lighting system can include a third linear actuator that can have a fully retracted length and a fully extended length; the fully extended length can substantially be a multiple of the fully retracted length of the actuator. The third linear actuator can have a base surface and a top surface and the light fixture frame can be mounted to the top surface of the third linear actuator. The third linear actuator can be mounted to the light fixture frame and positioned between the first linear actuator and the second linear actuator. The lighting system in embodiments of the disclosure can be used as a plant lighting system and can accurately and repeatedly provide grow light to developing plants.

In some embodiments of the disclosure the lighting system or plant lighting system can further include a grow media structure. The grow media structure in embodiments of the disclosure can include or can be configured to receive and retain a grow media. For example the grow media can be a fabric, rockwool, soil, coco coir, perlite, and the like, and the grow media can be supported on a tray. The grow media structure can further include a container that can be rigid or flexible. The container can include the tray to support grow media or the container can enclose the grow media. In hydroponic, aeroponic, and nutrient film techniques growing methods, the container can hold nutrient solutions, water, and fertilizers. The container can support grow media and drip irrigation. The container can include an inlet and an outlet for nutrient solutions, water, and other fluids. In embodiments of the disclosure, the grow media structure can have a height between the top surface and a bottom surface of the grow media structure that is less than the length of the fully retracted linear actuators and a base surface of the grow media structure can be positioned at or above the base surface of the fully retracted linear actuators and a top surface the grow media structure can be positioned at or below the top surface of the fully retracted linear actuators.

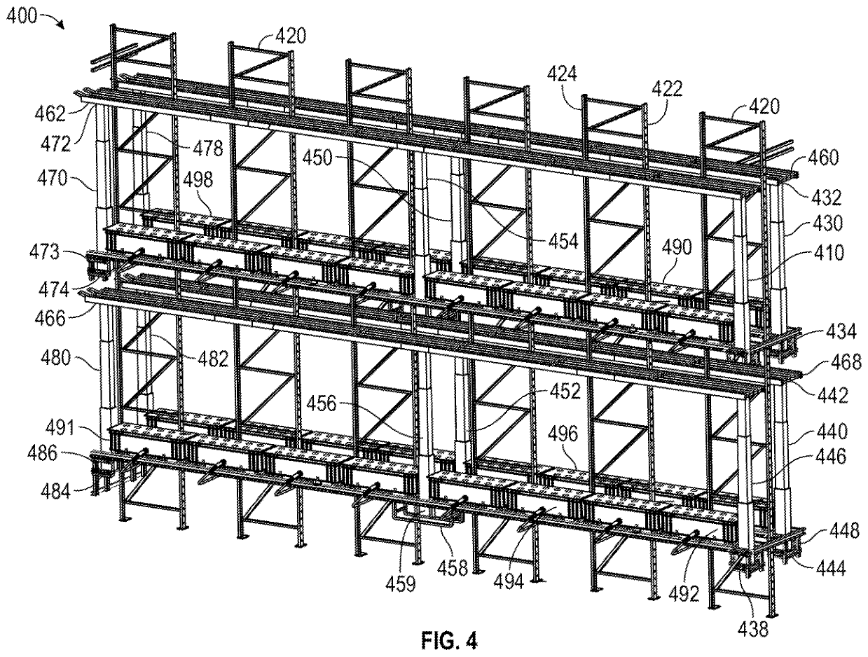

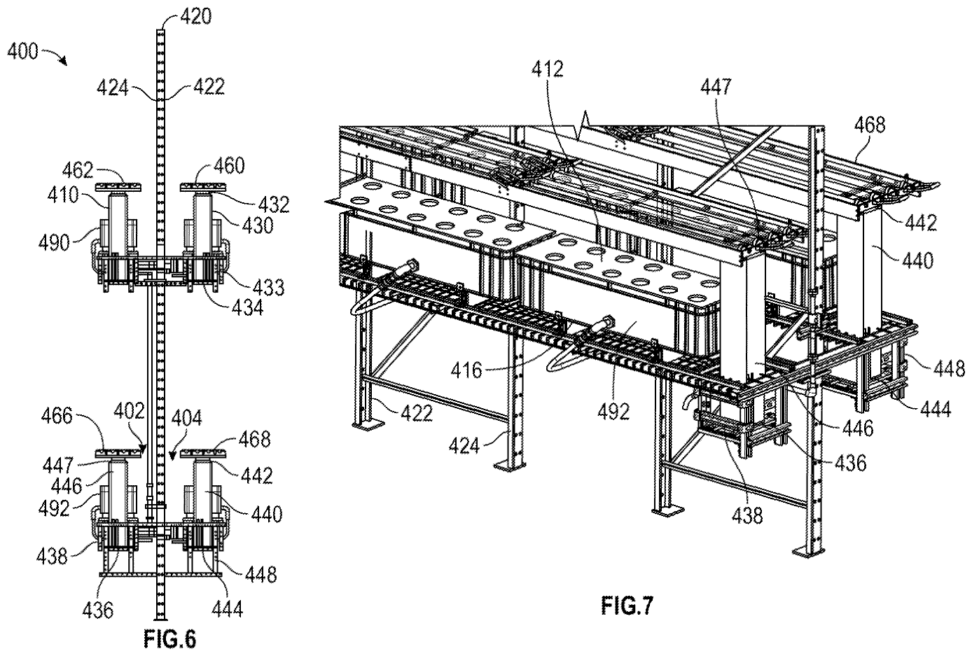

For example, as illustrated in FIG. 4, FIG. 6, and FIG. 7, the grow media structure unit 492 can have a top surface 412 and an opposing base surface 416. A distance between the top surface 412 and the base surface 416 is the height of the grow media structure 492. In embodiments of the disclosure the height of the grow media structure 492 can be less than the fully retracted length of the linear actuator 446 as illustrated in FIG. 4, FIG. 6, and FIG. 7. Further, a base surface 416 of the grow media structure 492 can be positioned at or above the base surface 436 of the fully retracted linear actuators 446 and a top surface 412 the grow media structure 492 can be positioned at or below the top surface 447 of the fully retracted linear actuator 446. This configuration ensures that the light fixture frame (e.g. 466) can be at or above the grow media structure (e.g. 492) when the actuators (e.g. 446) are fully retracted, which advantageously prevents damage to young plants and permits use of long stroke length linear actuators with multiple telescoping segment which is beneficial for growing and illuminating tall plants on the grow tower. In particular, the configuration ensures that the light fixture frame 466 does not come into contact with the top of the grow media structure 492, even at the fully retracted position of the linear actuators 446.

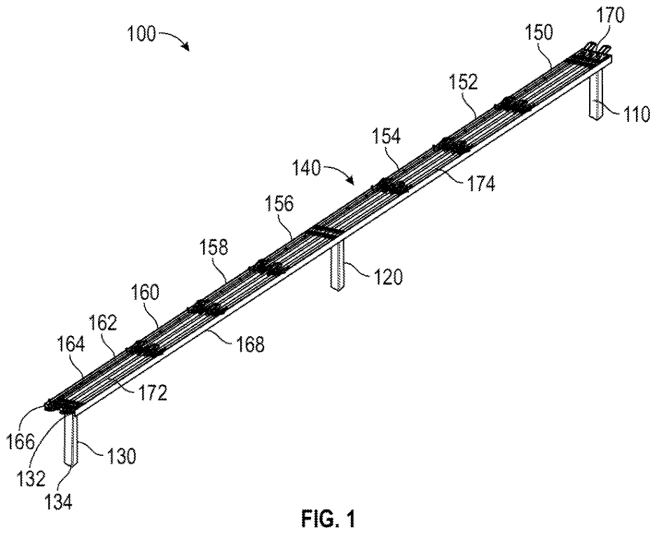

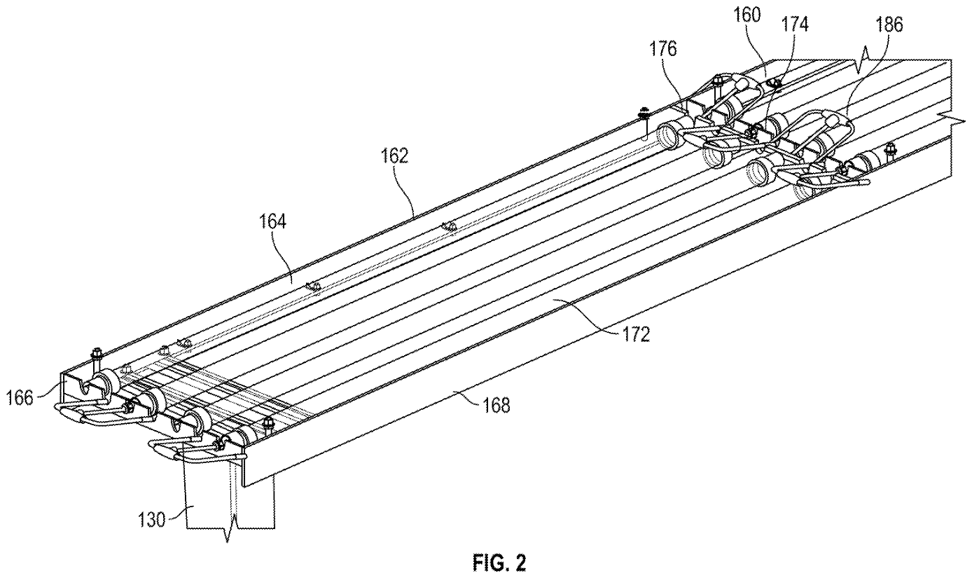

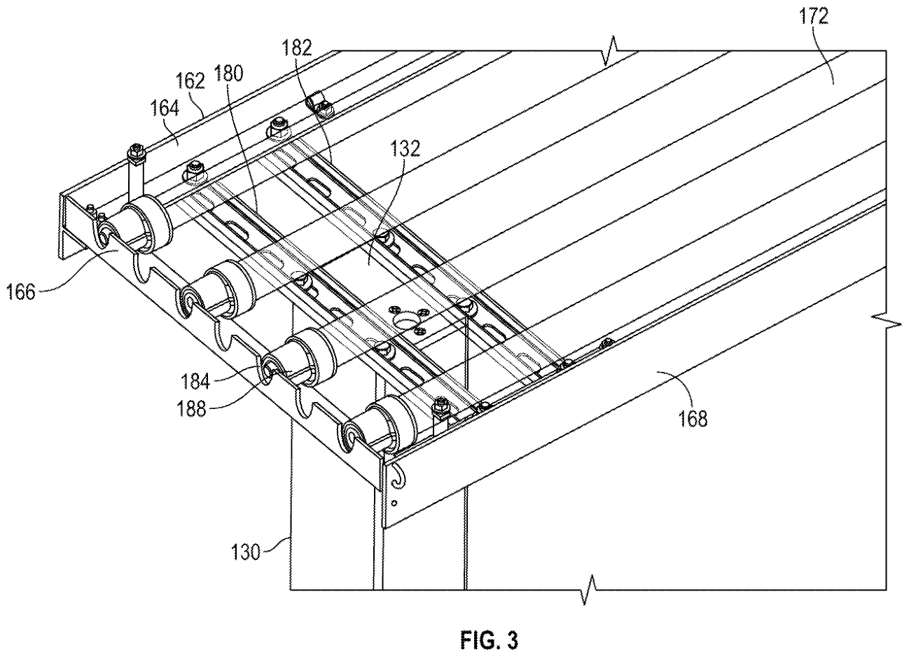

FIG. 1, FIG. 2, and FIG. 3 illustrate aspects of grow towers in embodiments of the disclosure that includes one or more lighting systems that can include light fixture frames and linear actuators. In FIG. 1, FIG. 2, and FIG. 3 like reference numerals refer to the same or similar elements in all of the various views in which that reference number appears.

FIG. 1 illustrates a lighting system or plant lighting system in an embodiment of the disclosure. The lighting system 100 is shown with three linear actuators 110, 120, and 130. Each of the linear actuators is shown in a retracted position, but the actuators 110, 120, 130 can be incrementally extended or retracted to selectively raise or lower the light fixture frame (e.g. see FIG. 4). A light fixture frame 140 is mounted to the actuators 110, 120, 130. Each of the actuators, for example actuator 130, can have a top surface 132 and an opposing base surface 134. The light fixture frame 140 can be mounted in part to the actuator top surface 132. The light fixture frame 140 can have a first side 166, a second side 170 opposite the first side 166, a third side 168 joining the first side 166 and the second side 170 together, and a fourth side 164 opposite the third side 168 that joins the first side and the second side 166, 170 together. The first and second sides 166, 170 can extend parallel or substantially parallel relative to each other, and the third and fourth sides 168, 164 can extend parallel or substantially parallel relative to each other. The light fixture frame 140 can have a unitary structure or can include one or more light fixture frame segments such as 150, 152, 154, 156, 158, 160, and 162 that can be joined together to form a single structure. The light fixture frame segments can support lighting lamps such as lamps 172 and 174.

FIG. 2 illustrates a portion of a lighting system 100 shown in FIG. 1 that shows the frame segment 160 and frame segment 162 joined together. Frame segment 162 is mounted to the top of linear actuator 130. In FIG. 2 also a lighting lamp 172 can be positioned on notches in first side 166 and member 176 of frame segment 162. A member 174 with notches for supporting lighting lamps 172 is shown on frame segment 160. The notches can be formed in the top surface or edge of the first side 166, member 176, and member 174 to ensure both horizontal and vertical alignment of the lighting lamps 172 relative to the light fixture frame 140. Adjacent lighting lamps 170 in frame segments can be electrically coupled together by daisy chain cables 186.

FIG. 3 details the end portion of frame segment 162 in the lighting fixture frame 140. FIG. 3 illustrates lighting lamp 172 supported in a notch 184 in first side member 166. A feature on the end fitting 188 of lighting lamp 172 is supported in the notch 184. FIG. 3 illustrates mounting of light fixture frame 140 through frame segment 162 on top surface 132 of linear actuator 130. The frame segment 162 can be fixtured to the top surface 132 by member 180 and member 182 (e.g., perpendicularly extending mounting beams) which are fixtured to third side 168 and fourth side 164. In embodiments of the disclosure the light fixture frame 140 can be made of light weight materials such as aluminum and carbon composites to minimize the load or weight that is moved by the linear actuators 110, 120, 130.

Eliminating cables that support the light fixture frame from above (e.g., with structures secured to the ceiling or a top frame of the assembly) with sets of linear actuators that support the light fixture frame from below (e.g., with actuators supported by the base of the assembly or floor of the facility) can greatly simplify the removal and replacement of lighting lamps for maintenance. Cables from the winches that were connected to the light fixture frame (as used in traditional systems) could interfere with the removal and insertion of elongated lamps from and into the notches. Without the cables from above in the exemplary system, the elongated lamps can simply be removed or replaced from above the light fixture frame. This improved access to the lighting lamps can improve uptime of the grow tower and reduce maintenance costs.

In embodiments of the disclosure the actuators that support the light fixture frame can have their bases fixtured or secured to a support. In some embodiments the support can be a floor or platform that is separate from the grow tower frame, the support can be a part or an extension of the grow tower frame, or the supports can be a combination of these. The base of the actuators can be secured near or proximate to the grow tower frame. The base of the actuators can be secured near or proximate to a front surface, rear surface, a side surface, or any combination of these, of the grow tower frame.

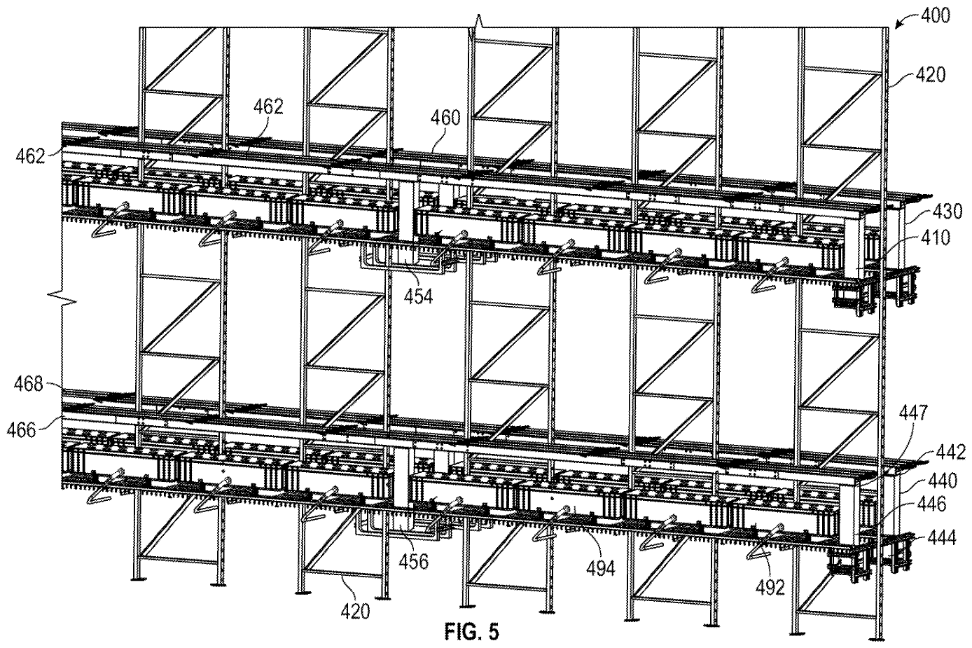

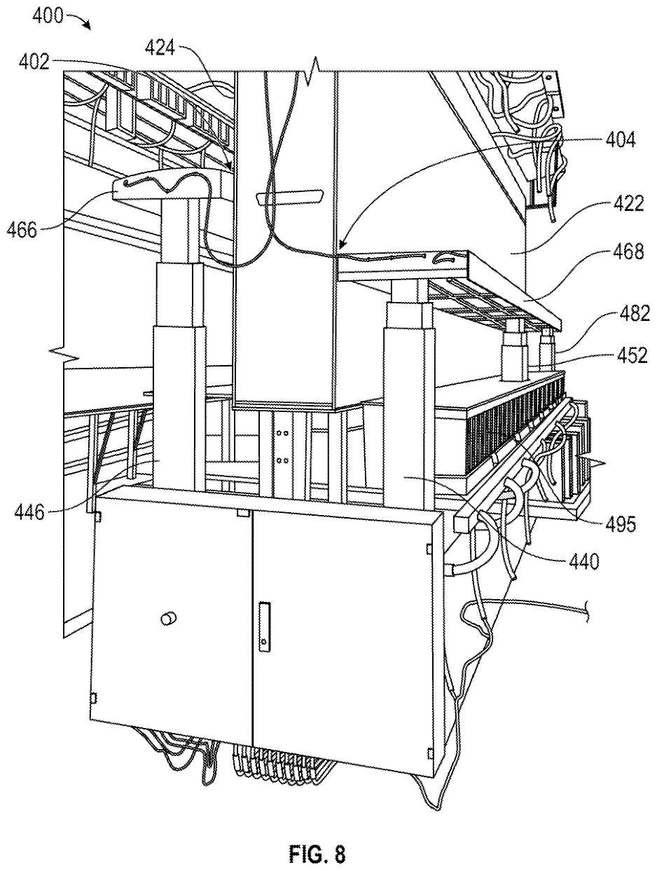

FIG. 4, FIG. 5, FIG. 6, FIG. 7, and FIG. 8 illustrate aspects of grow towers in embodiments of the disclosure that includes one or more plant lighting systems 100 that have light fixture frames and grow media structures. In FIG. 4, FIG. 5, FIG. 6, FIG. 7, and FIG. 8 like reference numerals refer to the same or similar elements in all of the various views in which that reference number appears.

FIG. 4 illustrates a grow tower 400 that includes a front side 424 and a rear side 422 and multiple levels and that can be made from frames 420. The frames 420 can support grow media structures (e.g. 490, 491, 492, 494, 495, 496, 498, etc.) on shelves or racks that extend outward from the frames 420. The frames 420 can support platforms (e.g. 433, 438, 448, 458, 474, etc.) to which the actuator base surfaces (e.g. 434, 436, 444, 459, 473, etc.) can be fixtured to. The illustrated grow tower 400 is shown with four lighting systems 100. The lighting system that includes lighting frame 460 positioned on a rear top side 422 of the frame 420 is illustrated being mounted to a top surface (e.g. 432) of extended linear actuators 430, 450, and 478; the lighting system that includes lighting frame 468 positioned on a rear lower side 422 of the frame 420 is illustrated being mounted to a top surface (e.g. 442) of extended linear actuators 440, 452, and 482; the lighting system that includes lighting frame 462 positioned on a top front side 424 of the frame 420 is illustrated being mounted to a top surface (e.g. 472) of extended linear actuators 410, 454, and 470; the lighting system that includes lighting frame 466 positioned on a lower front side 424 of the frame 420 is illustrated being mounted to a top surface (e.g. 447) of extended linear actuators 446, 456, and 480. FIG. 5 illustrates a more detailed perspective view of a portion of the grow tower 400 that includes a lighting system and grow media structure of FIG. 4.

As shown in FIG. 4, FIG. 5, FIG. 6 and FIG. 7, the actuators (e.g. 446, 456, and 480 on the front first level plant light system) can be mounted below the grow media structures (e.g. 491, 492, 494, etc.) where the plants (not shown) can be grown. The base surface of the actuators (e.g. 436, 459, 486) can be mounted in cage or support structures (e.g. 438, 458, 484) that are part of or extensions of the grow tower. Other examples of cage or support structures illustrated in FIG. 4 include 448 and 474. In embodiments of the disclosure the grow tower and support structures can be made from steel channel and struts.

FIG. 6 illustrates an end view of a grow tower 400 that includes one or more plant lighting systems. The grow tower 400 includes a frame 420 that supports the plant lighting systems. The frame 420 has a front surface or front side 424 and a rear surface or rear side 422. On a top level of the grow tower 400, a first plant lighting system consisting of a lighting fixture frame 460 that is mounted to linear actuator 430, and a second plant lighting system consisting of a lighting fixture frame 462 that is mounted to linear actuator 410. The actuators 410 and 430 are fixtured proximate to a first end portion of the top end of the grow tower. On a bottom level of the grow tower, a third plant lighting system consisting of a lighting fixture frame 468 that is mounted to linear actuator 440, and a fourth plant lighting system consisting of a lighting fixture frame 466 that is mounted to linear actuator 446. The actuators 440 and 446 are fixtured proximate to a first end portion of the bottom level of the grow tower. The grow tower 400 can include grow media structure 490 on a top level and grow media structure 492 on the bottom level. Grow media structure 490 is illustrated being positioned below lighting fixture frame 462 and grow media structure 492 is illustrated being positioned below lighting fixture frame 466.

FIG. 6 illustrates a gaps that can be created between the light fixture frames and surfaces of the grow tower frame. For example, a gap 402 can be formed between a front surface or plane 424 of the frame 420 and the third side of the light fixture frame 466. The distance of the actuator 446 from the surface 424 and the position where the actuator top surface and light fixture frame are mounted together between third side and fourth side of the light fixture frame (e.g. see FIG. 1) can be used to alter the size or length of the gap 402. A gap 404 is illustrated between the rear plane 422 of the frame 420 and the third side of the light fixture frame 468. Gaps are also illustrated in FIG. 6 between the light fixture frames and the frame surface of the upper level.

Synchronized linear actuators enable the smooth vertical translation of the light fixture frame between the retracted and extended positions across the grow tower surfaces. Synchronized linear actuators, unlike light fixture frames supported and translated using cables and winches, enable the extended light fixture frame to move without swinging, twisting, or sagging. Minimizing or eliminating light fixture frame motion and/or distortion can prevent damage to grow tower surfaces and keeps lights aligned both vertically and horizontally overtop of plants in the grow media structure. In particular, use of the linear actuators ensures that the light fixture frame is maintained parallel or substantially parallel to the top surface of the grow media structures, thereby providing even light distribution. Synchronized linear actuator further enables a smaller gap to be maintained between the light fixture frame and tower surface which can be advantageous in maintaining the intensity of light reflecting from the tower surface to the plants and for controlling heat dissipation from the lamps and airflow near the light fixture frames.

The linear motion of multiple linear actuators can automatically match with each other to synchronize the movement and position of the top surfaces of the actuators supporting the light fixture frame. The linear actuators can be wired to the same switch. The load of the light fixture frame on each of the multiple linear actuators can be balanced across the actuators. Synchronized motion control for the actuators can include either an open-loop control system using a speed controller or a closed-loop system utilizing feedback from the actuators to determine the individual needs of each device and make motion adjustments in real time.

In the fully retracted position, height of the linear actuators is dimensioned greater than the overall height of the grow media structures (as measured between top and bottom surfaces of the grow media structures), ensuring that even in the lowermost position the light fixture frame does not come into contact with the top surface of the grow media structure. This prevents potential damage to the developing plants. In some embodiments, the system can include a failsafe or security feature that positions each of the linear actuators into a fully extended position in the event of a power failure to prevent potential damage to the developing plants. In such embodiments, a reserve power source can be used to power the linear actuators to fully lift the light fixture frame.

In some embodiments, the system can include one or more sensors that detect the height of the developing plants in the grow media structure. The system can include a feedback loop that transmits the detected height of the developing plants (e.g., the greatest detected height), and an actuation signal can be automatically transmitted by the system to the linear actuators to appropriately raise or lower the light fixture frame to the optimal height for illumination of the developing plants. The system can thereby automatically adjust the position of the light fixture frame as the plants continue to develop and grow and prevents contact between the top of the plants and the light fixture frame.

FIG. 8 illustrates a perspective view of a portion of a grow tower 400. The grow tower includes a front side surface 424 and a rear side surface 422. A front side light fixture frame 466 is supported by partially extended linear actuator 446 and a gap 402 is present between the third side of the light fixture frame 466 and the front side surface 424. A rear side light fixture frame 468 is supported by partially extended linear actuator 440 and a gap 404 is present between the third side of the light fixture frame 468 and the light reflective rear side surface 422. A grow media structure 495 is illustrated below the light fixture frame 468. The actuators 446 and 440 are extended to different length which illustrates that the linear actuators of the grow system can be raised and lowered independently and can be controlled independently. Although illustrated as raising and lowering the entire light fixture frame for the length of the grow tower, in some embodiments, multiple intermediate linear actuators can support a light fixture frame segmented across the length of the grow tower such that the segmented light fixture frame sections can be independently raised and lowered relative to each other.

Embodiments of the disclosure can include a plant growth system that can have an upper light fixture frame that can be positioned above a grow media structure. The upper light fixture frame can include lighting lamps. The upper light fixture frame can be supported by a first set of one or more synchronized linear actuators that can raise and lower the upper light fixture frame. The grow media structure positioned below the upper light fixture frame can be supported by a separate second set of one or more synchronized linear actuators that can raise and lower the grow media structure. The plant grow system can optionally include a lower light fixture frame that can be separately positioned below the growth media structure. The lower light fixture frame can include lighting lamps. In some embodiments, the lower light fixture frame that can be separately positioned below the growth media structure can optionally be supported by a third set of one or more synchronized linear actuators (not shown) that can raise and lower the lower light fixture frame.

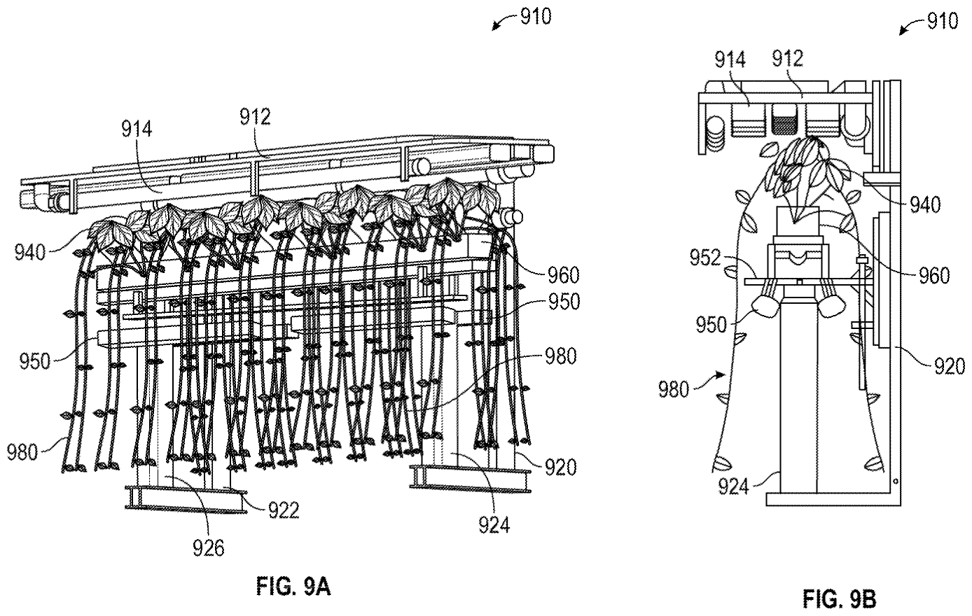

FIG. 9A and FIG. 9B illustrates a plant grow system 910 that can have an upper light fixture frame 912 that can be positioned above a grow media structure 960. The upper light fixture frame can include lighting lamps 914. The upper light fixture frame 912 can be supported by a first set of one or more synchronized linear actuators 920, 922 that can raise and lower the upper light fixture frame 912. The grow media structure 960 positioned below the upper light fixture frame can be supported by a separate second set of one or more synchronized linear actuators 924, 928 that can raise and lower the grow media structure. Plants 940 can develop from a grow media within the grow media structure. In some embodiments of the disclosure the plants 940 can produce stolons 980. Nutrients can be supplied to the grow media structure by fixtures (not shown). The plant grow system 910 can include a lower light fixture frame 952 that can be separately positioned below the growth media structure 960. The lower light fixture frame can include lighting lamps 950. In some embodiments, the lower light fixture frame below the growth media structure can be supported by a third set of one or more synchronized linear actuators (not shown) that can raise and lower the lower light fixture frame independently of the upper light fixture frame 912 and the grow media structure 960.

In embodiments of the plant grow system 910 of the disclosure the first set of linear actuators, the second set of linear actuators, and the third set of linear actuators can be raised and lowered independently. This can be advantageous for plants 940 that have a vegetative portion that grows upwards from a grow media towards an upper light fixture frame 912 with lighting lamps 914 and where the plants also can produce stolons 980 that can drape down from the grow media structure 960 and move toward a lower level or the floor.

For example, as the plants 940 develop and extend upward, the lighting lamps 914 in the upper level light fixture frame 912 can be moved up (automatically or manually) by the first set of linear actuators to maintain a light intensity and predetermined distance from the canopy of the plants 940; the position of the grow media structure 960 can remain the same or fixed. As stolons are produced by the developing plants 940 that drape over the grow media structure 960 they can contact the ground; the position of the grow media structure 960 can be raised up by the second set of linear actuators to move the stolons away from the ground and the first set of linear actuators can also be moved up to maintain the distance between the plant canopy and the lighting lamps 914 in the upper light fixture frame 912. The lower light fixture frame 952 can remain fixed below the grow media structure 960 and move with the grow media structure. In some embodiments, the lower light fixture frame 952 below the growth media structure 960 can be supported by a third set of one or more synchronized linear actuators (not shown) that can raise and lower the lower light fixture frame independently of the upper light fixture frame 912 and the grow media structure 960. Moving the lower light fixture 952 can advantageously provide lighting to the stolons between their lower (floor) position and their upper position (below the grow media structure).

Embodiments of the disclosure can include those where the linear actuators are synchronized linear actuators. The linear actuators can be electric, magnetic, pneumatic, rotary, or hydraulic. In some embodiments the linear actuators can be synchronized electric linear actuators. In some embodiments the actuators can extend by a two stage extension.

In some embodiments of the disclosure the light fixture frame can consist of sections joined together and wherein each light fixture frame section (e.g. 160, 162) supports a set of elongated lighting lamps. Studs and slots can be included in the light fixture frame 140 (e.g. in sides 164, 168) to hang white coroplast reflector panels from to further contain light within the grow area.

Each light fixture frame section can hold multiple lighting lamps (172), mounted into custom slotted angles 184 in members 174, 176. A set of bulbs can be daisy chained together by each bulb's electrical cabling 186 and an extension cable can be used to reach the next set of bulbs. The entire light fixture can be mounted to synchronized linear lifting columns, which can work with a wireless handset to lift the entire fixture to a maximum extension.

The following clauses define particular aspects and embodiments of the disclosure.

Clause 1. A plant lighting system comprising:
a light fixture frame that supports one or more lighting lamps, the light fixture frame has a first side, a second side opposite the first side, a third side joining the first side and the second side, and a fourth side opposite the third side that joins the first side and the second side;
a first linear actuator that has a fully retracted length and a fully extended length, the (fully) extended length is substantially a multiple of the (fully) retracted length (segments nest within one another), the first linear actuator has a base surface and a top surface; a second linear actuator that has a fully retracted length and a fully extended length, the fully extended length is substantially a multiple of the fully retracted length, the second linear actuator has a base surface and a top surface, the second linear actuator spaced from the first linear actuator, (the first linear actuator and the second linear actuator comprising segments, the linear actuators extend and retract the segments telescopically);
the light fixture frame mounted to the top surface of the first linear actuator and the light fixture frame mounted to the top surface of the second linear actuator (the light fixture frame spans (can extend past, can be between) the first linear actuator and the second linear actuator).

Clause 2. The plant lighting system as in clause 1 further comprising a third linear actuator that has a fully retracted length and a fully extended length, the fully extended length is substantially a multiple of the fully retracted length, the third linear actuator has a base surface and a top surface, the light fixture frame mounted to the top surface of the third linear actuator and the third linear actuator mounted to the light fixture frame between the first linear actuator and the second linear actuator.

Clause 3. The plant lighting system as in any one of clauses 1-2 further comprising a grow media structure (e.g. grow media with or without container or support for hydroponic, aeroponic, nutrient film technique, drip irrigation), a height of the grow media structure is less than the fully retracted length of the linear actuators, a base surface of the grow media structure is positioned at or above the base surface of the fully retracted linear actuators and a top surface the grow media structure is positioned at or below the top surface of the fully retracted linear actuators.

Clause 4. The plant lighting system as in any one of clauses 1-3 wherein the grow media structure is positioned below the light frame fixture when the linear actuators are at the fully retracted length.

Clause 5. The grow tower comprising the plant lighting system as in any one of clauses 1-4, wherein the base of the first linear actuator is fixtured proximate to a first end portion of the grow tower and the base of the second linear actuator is fixtured proximate to a second end portion of the grow tower, the light fixture frame spans the first end portion of the grow tower and the second end portion of the grow tower, the third side of the light fixture frame nearest the grow tower is separated by at least a gap from a surface or plane of the grow tower.

Clause 6. The grow tower comprising the plant lighting system of clause 5 further comprising the third linear actuator, the base of the third linear actuator is fixtured proximate to the grow tower. (the third linear actuator positioned between the first linear actuator and the second linear actuator and can be aligned with the first and second).

Clause 7. The grow tower comprising the plant lighting system as in any one of clauses 5-6 wherein the base of the first linear actuator is fixtured to the first end portion of the grow tower and the base of the second linear actuator is fixtured to the second end portion of the grow tower.

Clause 8. The grow tower comprising the plant lighting system as in any one of clauses 5-7 wherein the base of the third linear actuator is fixtured to the grow tower.

Clause 9. The grow tower comprising the plant lighting system as in any one of clauses 5-8, wherein the third side of the light fixture frame nearest the grow tower is separated by the gap from a surface or plane of the grow tower during vertical movement of the light fixture frame from a position where the actuators are fully retracted and the position where the actuators are fully extended.

Clause 10. The grow tower comprising the plant lighting system as in any one of clauses 5-9 wherein the base surface of the first linear actuator is positioned at or below a base surface of the grow media structure and the top surface of the first linear actuator is positioned at or above the grow media structure when the first linear actuator is in the fully retracted position; the base surface of the second linear actuator is positioned at or below the base surface of grow media structure and the top surface of the second linear actuator is positioned at or above the top surface of the grow media structure when the second linear actuator is in the fully retracted position.

Clause 11. The grow tower comprising the plant lighting system as in any one of clauses 5-10 comprising a third linear actuator, the base surface of the third linear actuator positioned at or below the base surface of the grow media structure and the top surface of the third linear actuator is positioned at or above the top surface of the growth media structure when the third linear actuator is in a fully retracted position (advantage is that the lights start a fixed distance above the plants/grow media).

Clause 12. The grow tower comprising the plant lighting system as in any one of clauses 5-11 wherein the grow media structure comprises a container (provides nutrient liquid to plant roots and can contain and/or support grow media).

Clause 13. The grow tower comprising the plant lighting system as in any one of clauses 5-12 comprising two or more independently controllable (e.g. position, light intensity, etc) plant lighting systems.

Clause 14. A plant grow system comprising:
a light fixture frame comprising one or more lighting lamps, the light fixture frame supported by a first set of linear actuators (set can be one, two, or more linear actuators); and,
a grow media structure comprising a grow media and a container, the grow media structure supported by a second set of linear actuators;
the first set of linear actuators and the second set of linear actuators are separated from each other and the first set of linear actuators and the second set of linear actuators can be raised and lowered independently.

Clause 15. The plant grow system of clause 14 wherein the grow media structure further comprises a light fixture frame positioned below grow media structure.

Clause 16. The plant grow system of clause 15 wherein the light fixture frame positioned below the grow media structure is supported by a third set of linear actuators and the first set of linear actuators, the second set of linear actuators, and the third set of linear actuators can be raised and lowered independently.

Clause 17. A method of growing plants in the plant grow system as in any one of clauses 14-16 comprising:
a. changing a height of the light fixture frame by actuating the first set of linear actuators to maintain a substantially constant separation between the lighting lamps and the grow media structure or a plant shoot system developing within the grow media structure;
b. changing a height of the grow media structure by actuating the second set of synchronized linear actuators to maintain a separation between the plant shoot system and an obstruction (ground, lights, frames) below or above the grow media structure;
C. changing a height of the light fixture frame positioned below the grow media structure; or
d. any combination of (a), (b), and (c)

Clause 18. The method of clause 17 wherein the plants produce stolons.

Clause 19. The linear actuators as in any one of clauses 1-18 wherein the linear actuators are synchronized.

Clause 20. The light fixture frame as in any one of clauses 1-19 wherein the frame is comprised of sections joined together and wherein each section supports a set of elongated lighting lamps.

Clause 21. The linear actuators as in any one of clauses 1-20 wherein the linear actuators are rigid between the retracted position and the extended position.

Clause 22. The light fixture frames as in any one of clauses 1-21 wherein the light fixture frames are substantially rigid between the linear actuators.

Clause 23. A method of growing plants in a plant grow system, the method comprising:
actuating a first linear actuator to move between a fully retracted length and a fully extended length to change a height of a light fixture frame of the plant grow system; and
actuating a second linear actuator to move between a fully retracted length and a fully extended length simultaneously to actuation of the first linear actuator to change the height of the light fixture frame of the plant grow system;
wherein the light fixture frame supports one or more lighting lamps, and the light fixture frame has a first side, a second side opposite the first side, a third side joining the first side and the second side, and a fourth side opposite the third side that joins the first side and the second side;
wherein the fully extended length of the first and second linear actuators is substantially a multiple of the fully retracted length of the first and second linear actuators, and each of the first and second linear actuators has a base surface and a top surface;
wherein the second linear actuator is spaced from the first linear actuator; and
wherein the light fixture frame is mounted to the top surface of the first and second linear actuators.

Approximating language, as used herein throughout the specification and claims, may be applied to modify any quantitative or qualitative representation that could permissibly vary without resulting in a change in the basic function to which it is related. Accordingly, a value modified by a term such as “about” or numerical ranges is not to be limited to a specified precise value, and may include values that differ from the specified value. In at least some instances, the approximating language may correspond to the precision of an instrument for measuring the value.

It will be apparent to those skilled in the art that various modifications and variations can be made in the method and system of the present disclosure without departing from the spirit or scope of the disclosure. Thus, it is intended that the present disclosure include modifications and variations that are within the scope of the appended claims and their equivalents.

While the disclosure has been described in detail in connection with only a limited number of aspects and embodiments, it should be understood that the disclosure is not limited to such aspects. Rather, the disclosure can be modified to incorporate any number of variations, alterations, substitutions, or equivalent arrangements not heretofore described, but which are commensurate with the scope of the claims. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. A plant lighting system comprising:
a light fixture frame that supports one or more lighting lamps, the light fixture frame has a first side, a second side opposite the first side, a third side joining the first side and the second side, and a fourth side opposite the third side that joins the first side and the second side;
a first linear actuator that has a fully retracted length and a fully extended length, the fully extended length is substantially a multiple of the fully retracted length, the first linear actuator has a base surface and a top surface;
a second linear actuator that has a fully retracted length and a fully extended length, the fully extended length is substantially a multiple of the fully retracted length, the second linear actuator has a base surface and a top surface, the second linear actuator spaced from the first linear actuator; and
the light fixture frame mounted to the top surface of the first linear actuator and the light fixture frame mounted to the top surface of the second linear actuator such that the light fixture frame spans the first linear actuator and the second linear actuator.

2. The plant lighting system as in claim 1, further comprising a third linear actuator that has a fully retracted length and a fully extended length, the fully extended length is substantially a multiple of the fully retracted length, the third linear actuator has a base surface and a top surface, the light fixture frame mounted to the top surface of the third linear actuator and the third linear actuator mounted to the light fixture frame between the first linear actuator and the second linear actuator.

3. The plant lighting system as in claim 1, further comprising a grow media structure, a height of the grow media structure is less than the fully retracted length of the linear actuators, a base surface of the grow media structure is positioned at or above the base surface of the fully retracted linear actuators and a top surface the grow media structure is positioned at or below the top surface of the fully retracted linear actuators.

4. The plant lighting system as in claim 1, wherein the grow media structure is positioned below the light frame fixture when the linear actuators are at the fully retracted length.

5. The A grow tower comprising the plant lighting system as in claim 1, wherein the base of the first linear actuator is fixtured proximate to a first end portion of the grow tower and the base of the second linear actuator is fixtured proximate to a second end portion of the grow tower, the light fixture frame spans the first end portion of the grow tower and the second end portion of the grow tower, the third side of the light fixture frame nearest the grow tower is separated by at least a gap from a surface or plane of the grow tower.

6. The grow tower comprising the plant lighting system of claim 5, further comprising the third linear actuator, the base of the third linear actuator is fixtured proximate to the grow tower.

7. The grow tower comprising the plant lighting system as in claim 5, wherein the base of the first linear actuator is fixtured to the first end portion of the grow tower and the base of the second linear actuator is fixtured to the second end portion of the grow tower.

8. The grow tower comprising the plant lighting system as in claim 5, wherein the base of the third linear actuator is fixtured to the grow tower.

9. The grow tower comprising the plant lighting system as in claim 5, wherein the third side of the light fixture frame nearest the grow tower is separated by the gap from a surface or plane of the grow tower during vertical movement of the light fixture frame from a position where the actuators are fully retracted and the position where the actuators are fully extended.

10. The grow tower comprising the plant lighting system as in claim 5, wherein the base surface of the first linear actuator is positioned at or below a base surface of the grow media structure and the top surface of the first linear actuator is positioned at or above the grow media structure when the first linear actuator is in the fully retracted position; the base surface of the second linear actuator is positioned at or below the base surface of grow media structure and the top surface of the second linear actuator is positioned at or above the top surface of the grow media structure when the second linear actuator is in the fully retracted position.

11. The grow tower comprising the plant lighting system as in claim 5, comprising a third linear actuator, the base surface of the third linear actuator positioned at or below the base surface of the grow media structure and the top surface of the third linear actuator is positioned at or above the top surface of the growth media structure when the third linear actuator is in a fully retracted position.

12. The grow tower comprising the plant lighting system as in claim 5, wherein the grow media structure comprises a container.

13. The grow tower comprising the plant lighting system as in claim 5, comprising two or more independently controllable plant lighting systems.

14. A plant grow system comprising:
a light fixture frame comprising one or more lighting lamps, the light fixture frame supported by a first set of linear actuators; and
a grow media structure comprising a grow media and a container, the grow media structure supported by a second set of linear actuators;
wherein the first set of linear actuators and the second set of linear actuators are separated from each other and the first set of linear actuators and the second set of linear actuators can be raised and lowered independently.

15. The plant grow system of claim 14, wherein the grow media structure further comprises a light fixture frame positioned below grow media structure.

16. The plant grow system of claim 15, wherein the light fixture frame positioned below the grow media structure is supported by a third set of linear actuators and the first set of linear actuators, the second set of linear actuators, and the third set of linear actuators can be raised and lowered independently.

17. A method of growing plants in the plant grow system as in claim 14, comprising:
a. changing a height of the light fixture frame by actuating the first set of linear actuators to maintain a substantially constant separation between the lighting lamps and the grow media structure or a plant shoot system developing within the grow media structure;
b. changing a height of the grow media structure by actuating the second set of synchronized linear actuators to maintain a separation between the plant shoot system and an obstruction below or above the grow media structure;
c. changing a height of the light fixture frame positioned below the grow media structure; or
d. any combination of (a), (b), and (c)

18. The method of claim 17, wherein the plants produce stolons.

19. The plant lighting system as in claim 1, wherein the linear actuators are synchronized.

20. The plant lighting system as in claim 1, wherein the light fixture frame is comprised of sections joined together and wherein each section supports a set of elongated lighting lamps.

21. A method of growing plants in a plant grow system, the method comprising:
actuating a first linear actuator to move between a fully retracted length and a fully extended length to change a height of a light fixture frame of the plant grow system; and
actuating a second linear actuator to move between a fully retracted length and a fully extended length simultaneously to actuation of the first linear actuator to change the height of the light fixture frame of the plant grow system;
wherein the light fixture frame supports one or more lighting lamps, and the light fixture frame has a first side, a second side opposite the first side, a third side joining the first side and the second side, and a fourth side opposite the third side that joins the first side and the second side;
wherein the fully extended length of the first and second linear actuators is substantially a multiple of the fully retracted length of the first and second linear actuators, and each of the first and second linear actuators has a base surface and a top surface;
wherein the second linear actuator is spaced from the first linear actuator; and
wherein the light fixture frame is mounted to the top surface of the first and second linear actuators.
